(19) United States
(12) Patent Application Publication
(10) Pub. No.: US 2025/0319805 A1
(43) Pub. Date: Oct. 16, 2025

(54) SYSTEM AND METHOD FOR PROVIDING POWER TO A CUP HOLDER

(71) Applicant: Rivian IP Holdings, LLC, Irvine, CA (US)

(72) Inventors: William Kirk Robinson, Newport Beach, CA (US); Kaitlyn Olah, Irvine, CA (US); Abishek Sadhu Anchan, Irvine, CA (US); Matthew Matera, Newport Beach, CA (US); Nathan Philip Wang, Costa Mesa, CA (US)

(21) Appl. No.: 18/637,115

(22) Filed: Apr. 16, 2024

(51) Int. Cl. B60N 3/10; B60R 16/033; H02J 7/00

(52) U.S. Cl. CPC B60N 3/10; B60R 16/033; H02J 7/0044; H02J 7/0049; H02J 2310/70

(57) ABSTRACT

A system includes a cupholder of a vehicle that receives and provides power to an accessory device. The cupholder includes electrical contacts to engage electrical contacts of the accessory device. The system further includes control circuitry configured to determine whether to provide the power to the electrical contacts of the cupholder. In some embodiments, the cupholder further includes a retaining mechanism to retain the accessory device in the cupholder. In some embodiments, the cupholder includes a retaining frame forming a cup well to secure sides of the accessory device and a movable base to support the bottom of the accessory device. The movable base is movable in relation to the retaining frame. The electrical contacts of the cupholder are disposed in the movable base.

### INTRODUCTION

The present disclosure is directed to a system and method for providing power to a cupholder of a vehicle, and more particularly to a system and method for providing power to an accessory device disposed in the cupholder.

### SUMMARY

A vehicle may include a device for holding cups, which may be a cupholder. The cupholder may be used to hold cups, such as refillable beverage containers, water bottles, and soft drink cups, to name a few examples. The cupholder may also be used as a receptacle to hold personal items such as a cellular phone, wallet, or sunglasses.

In some embodiments, the present disclosure is directed to a system comprising a cupholder of a vehicle configured to receive and provide power to an accessory device and control circuitry. The cupholder comprises electrical contacts configured to engage electrical contacts of the accessory device. The control circuitry is configured to determine whether to provide the power to the electrical contacts of the cupholder. In some embodiments, the cupholder further comprises a retaining mechanism configured to retain the accessory device in the cupholder. In some embodiments, the cupholder further comprises a retaining frame forming a cup well and a movable base. The cup well secures sides of the accessory device. The movable base supports the bottom of the accessory device. The movable base is movable in relation to the retaining frame. The electrical contacts of the cupholder are disposed in the movable base.

In some embodiments, the present disclosure is directed to a method comprising identifying a presence of an accessory device in a cupholder and determining whether to provide power to the accessory device. In some embodiments, determining whether to provide the power to the accessory device comprises determining the accessory device is retained in the cupholder. In some embodiments, the method further comprises locking the accessory device in the cupholder.

In some embodiments, the present disclosure is directed to a system comprising a cupholder of a vehicle and control circuitry. The cupholder is configured to receive an accessory device and provide power to the accessory device. The cupholder comprising a retaining frame forming a cup well to secure sides of the accessory device. The cupholder further comprises a movable base to support the bottom of the accessory device. The movable base is movable in relation to the retaining frame. The cupholder further comprises electrical contacts disposed in the movable base configured to engage electrical contacts of the accessory device. The control circuitry is configured to provide the power to the electrical contacts of the cupholder to charge the accessory device.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

FIG. 1 shows a block diagram of an illustrative vehicle having a powered cupholder system, in accordance with some embodiments of the present disclosure;

FIG. 2 shows a block diagram of an illustrative system for providing power to a cupholder, in accordance with some embodiments of the present disclosure;

FIG. 3A is a schematic cutaway illustration of a powered cupholder system, in accordance with some embodiments of the present disclosure;

FIG. 3B is a schematic assembly illustration of the powered cupholder system of FIG. 3A, in accordance with some embodiments of the present disclosure;

FIG. 3C is a schematic sectional view of the powered cupholder system of FIG. 3B, in accordance with some embodiments of the present disclosure;

FIGS. 4A-4C are schematic assembly illustrations of another powered cupholder system, in accordance with some embodiments of the present disclosure;

FIGS. 5A-5D are schematic illustrations of different retaining mechanisms for a powered cupholder system, in accordance with some embodiments of the present disclosure;

FIG. 6 is a schematic illustration of a powered cupholder system, in accordance with some embodiments of the present disclosure;

FIGS. 7A-7D are schematic illustrations of accessory devices, in accordance with some embodiments of the present disclosure; and

FIG. 8 is a flowchart of an illustrative process for providing power to a cupholder, in accordance with some embodiments of the present disclosure.

### DETAILED DESCRIPTION

A vehicle may include a holder, storage receptacle, or location for placing beverage containers or personal items of a user. In some situations, the user may want to hold or store one or more powered accessory devices in the vehicle. Such devices require power to use and may include a battery. Over time, the battery may discharge from use or during storage. In some situations, the user may want to provide power to the accessory device, such as to use the accessory device or to charge the battery of the accessory device. In some embodiments, the present disclosure is directed to methods and systems for providing power to an accessory device contained within the holder, storage receptacle, or location. In some embodiments, the holder, storage receptacle, or location is a cupholder of the vehicle. In some embodiments, the cupholder includes electrical contacts to engage electrical contacts of the accessory device.

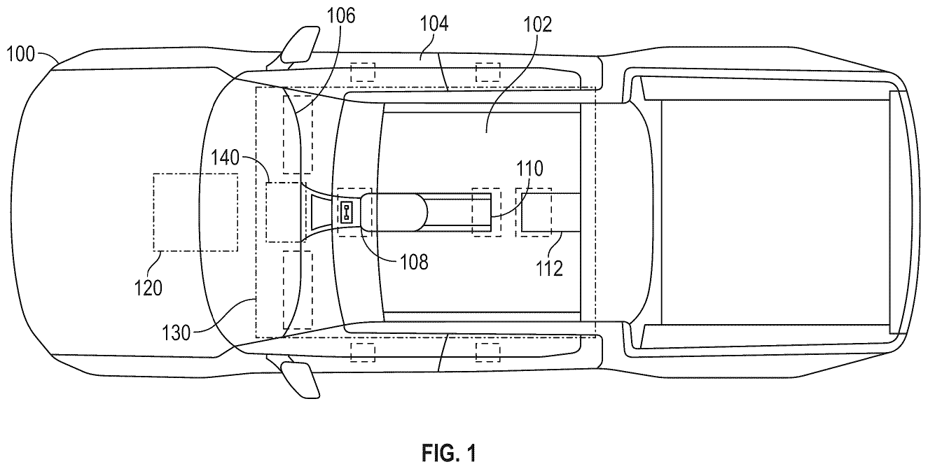

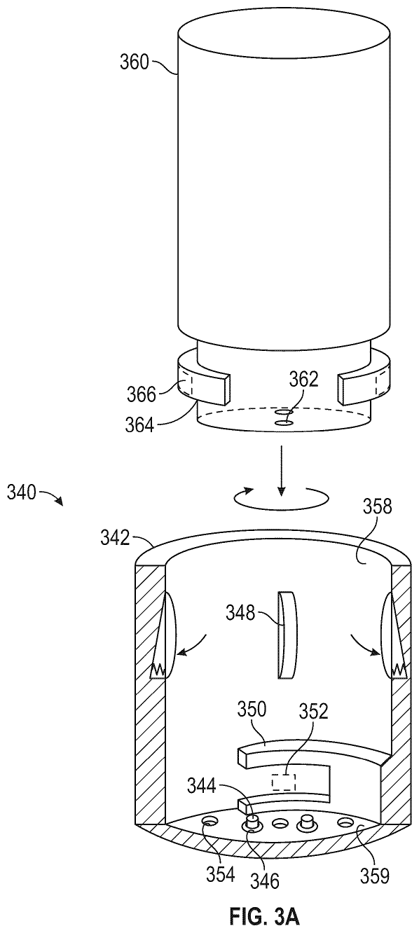

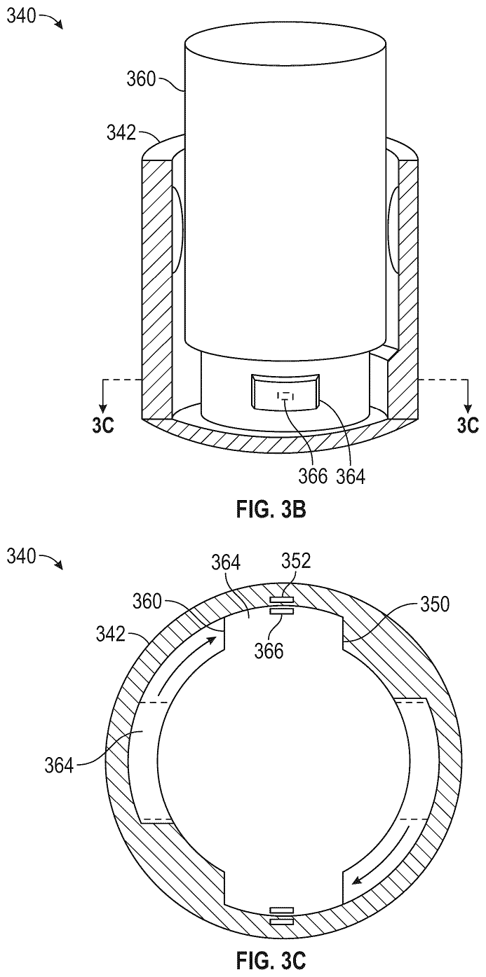

FIG. 1 shows a block diagram of an illustrative vehicle 100 having a powered cupholder system 140, in accordance with some embodiments of the present disclosure. As illustrated, the vehicle 100 includes control system 120, battery system 130, and the powered cupholder system 140. The powered cupholder system 140 provides power to a cupholder (e.g., cupholder 342, 442, 542A-D, 642, discussed below in relation to FIGS. 3A-3C, 4, 5A-5D, and 6) of the vehicle 100. The powered cupholder system 140 may provide power to an accessory device (e.g., accessory device 360, 560A-D, 760A-D discussed below in relation to FIGS. 3A-3C, 5A-5D, and 7) through the cupholder, such as to power the accessory device or charge a battery of the accessory device.

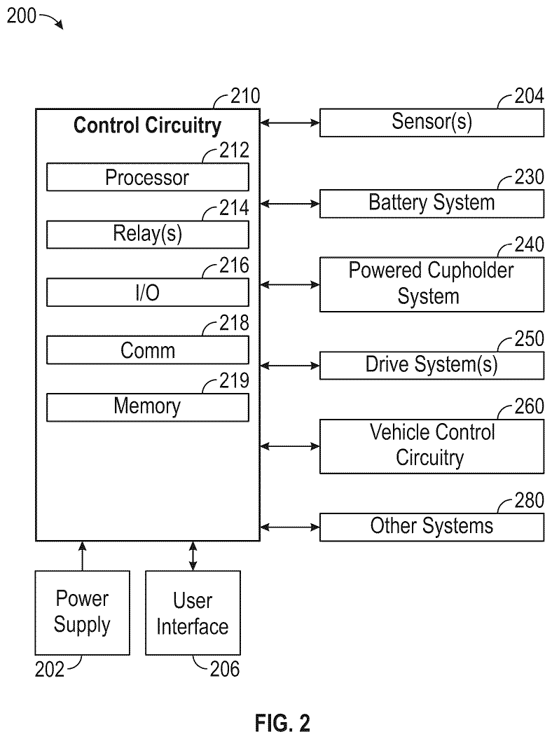

The control system 120 includes control circuitry (e.g., control circuitry 210, discussed below in relation to FIG. 2) that is coupled to sensors, actuators, interfaces, and any other suitable components to control one or more systems such as powered cupholder system 140. The control system 120 may include control circuitry for monitoring sensor signals, generating control signals, executing computer readable instructions, receiving inputs, or a combination thereof. In some embodiments, the powered cupholder system 140 includes a power delivery system such as, for example, a system having controllable electrical contacts for providing power. The battery system 130 (e.g., also referred to as an energy storage system or ESS) may include a plurality of battery cells, enclosures, and power electronics (e.g., a DC-DC converter, switches, alternator). The battery system 130 provides power to the powered cupholder system 140. The vehicle 100 may include drive units that may include motors, gearing, bearings, hubs, shafts, gearbox housings, any other suitable components, or any combination thereof. For example, each drive unit may include an inverter, electric motor, and a gearbox for providing torque to a respective wheel or drive axis of the electric vehicle via a half-shaft and constant-velocity (CV) joint.

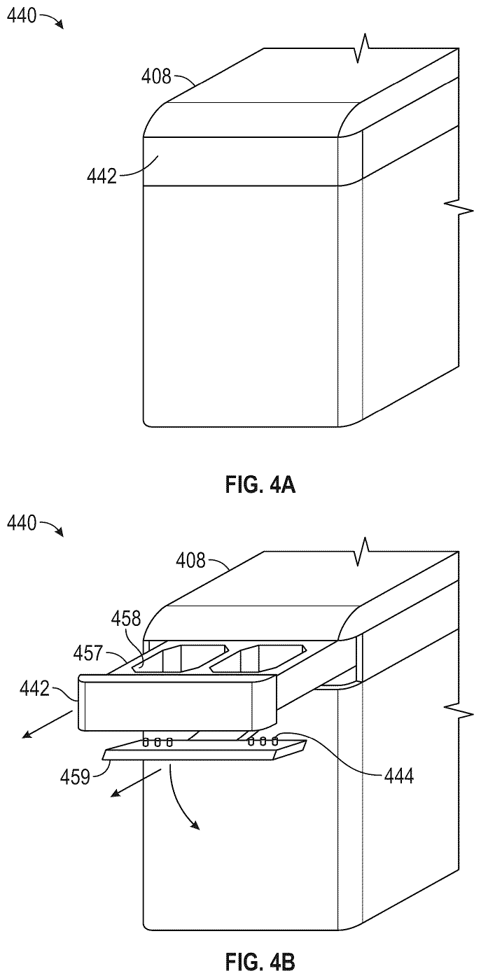

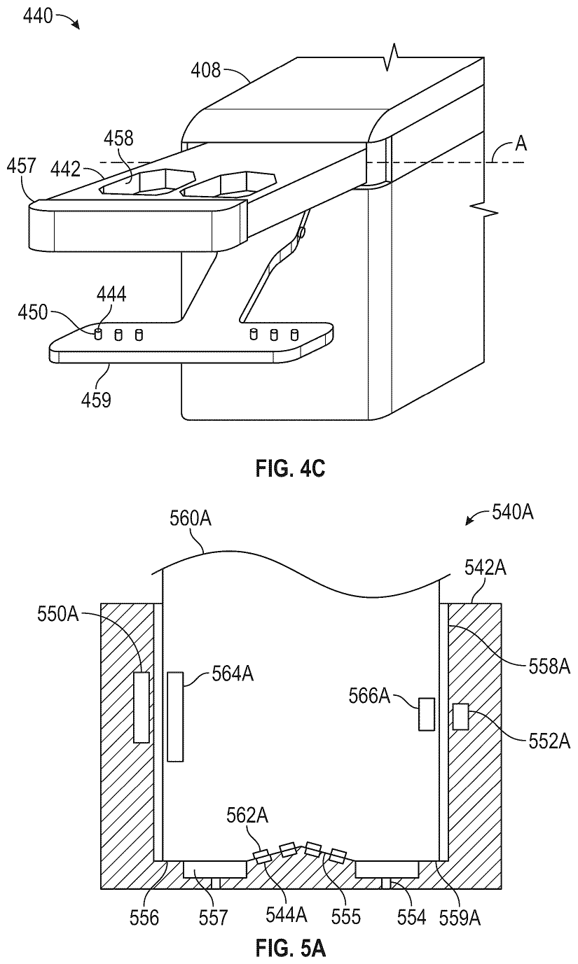

The vehicle 100 includes an interior 102 to accommodate passengers. Powered cupholders are positioned throughout the interior 102. In the embodiment depicted in FIG. 1, one or more powered cupholders may be present in each area marked by the dashed outlines. The vehicle 100 includes doors 104, such as a front and rear driver-side and passenger-side doors 104, to access the interior 102. The doors 104 have an interior side that faces the interior 102 and an opposite exterior side. The interior side of the door 104 may include a powered cupholder. The interior includes a driver's seat, front passenger seat, and rear passenger seat or seats (not shown). The interior includes a dashboard 106, front console 108, rear console 110, and rear armrest 112. The dashboard may include indicators, such a speedometer and tachometer, air vents, an entertainment or infotainment system screen, vehicle controls, and a powered cupholder. The front console 108 may include a storage compartment between the driver's seat and front passenger seat and a powered cupholder. The rear console 110 may include air vents and a powered cupholder. In some embodiments, such as discussed below in relation to FIGS. 4A-4C, the powered cupholder may be stowed inside any of the dashboard 106, front console 108, rear console 110, or rear armrest 112.

Although the embodiment depicted in FIG. 1 shows powered cupholders in particular locations of the vehicle 100, in some embodiments the powered cupholders may be located in different locations. For example, a powered cupholder may be located on a floor of the vehicle, such as near the front or rear consoles 108, 110, or in a bed or trunk of the vehicle 100. In some embodiments, the vehicle 100 may include more or less powered cupholders than discussed in relation to FIG. 1.

FIG. 2 shows a block diagram of an illustrative system 200 for providing power to a cupholder (e.g., cupholder 342, 442, 542A-D, 642, discussed below in relation to FIGS. 3A-3C, 4, 5A-5D, and 6), in accordance with some embodiments of the present disclosure. The system 200 includes control circuitry 210, a sensor(s) 204, battery system 230, powered cupholder system 240, a drive system(s) 250, vehicle control circuitry 260, and other systems 280. For example, system 200 may be included as part of the vehicle 100 of FIG. 1, where control circuitry 210 may correspond to the control system 120, the battery system 230 corresponds to the battery system 130, and powered cupholder system 240 may correspond to the powered cupholder system 140.

In an illustrative example, control circuitry 210 may monitor and control powered cupholder system 240, and determine when and if power is needed (e.g., based on a presence of an accessory device, moisture, sensor signals, reference information, preference information, and/or user input). Vehicle control circuitry 260 may be configured to manage providing power for any or all cupholders of a vehicle (e.g., vehicle 100). In an illustrative example, drive system(s) 250 may include drivetrain components such as a plurality of drive units, a plurality of electric motors (e.g., four electric motors, corresponding to a respective wheel of a vehicle), or otherwise one or more systems for generating torque at wheels of the vehicle. Powered cupholder system 240, as illustrated, may include one or sensors, electrical contacts, and controls for managing power to and from the cupholders.

Although illustrated as separate, powered cupholder system 240 and control circuitry 210 may overlap, be interfaced to each other via one or more components (e.g., wires, circuit boards, dies, chips, vias, connectors, resistors, transformers, capacitors), or otherwise be modified from system 200 as illustrated. Further, the boundary delineating each system is merely illustrative. Accordingly, system delineations illustrated herein are merely exemplary for purposes of discussion.

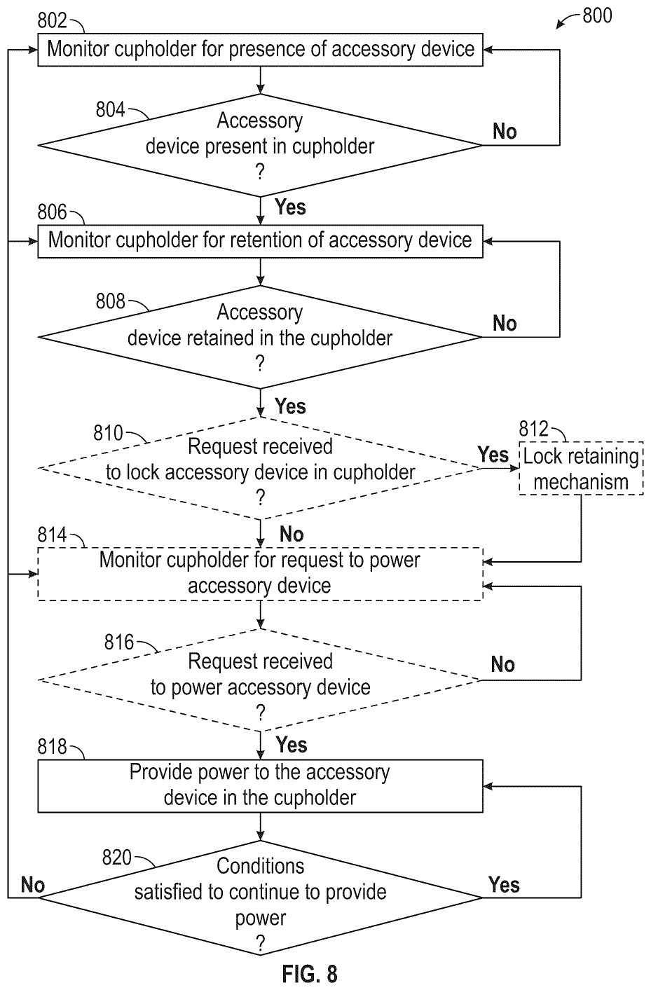

Illustrative control circuitry 210 includes processor 212, one or more relays 214 (hereinafter referred to as relay(s) 214), input/output 216 (hereinafter referred to as I/O 216), communication hardware 218 (hereinafter referred to as COMM 218), and memory 219. Control circuitry 210 may include hardware, software, or both, implemented on one or more modules configured to provide control of the powered cupholder system 240. In some embodiments, processor 212 includes one or more microprocessors, microcontrollers, digital signal processors, programmable logic devices, field-programmable gate arrays (FPGAs), application-specific integrated circuits (ASICs), or any suitable combination thereof. In some embodiments, processor 212 is distributed across more than one processor or processing units. In some embodiments, control circuitry 210 executes instructions stored in memory (e.g., non-transitory computer readable media) for managing power to the cupholder. In some embodiments, memory 219 is an electronic storage device that is part of control circuitry 210. For example, memory 219 may be configured to store electronic data, computer instructions, applications, firmware, or any other suitable information. In some embodiments, memory 219 includes random-access memory, read-only memory, hard drives, optical drives, solid state devices, or any other suitable memory storage devices, or any combination thereof. For example, memory 219 may be used to launch a start-up routine, diagnostic routine, or power-management routine. In some embodiments, memory 219 includes non-transitory computer-readable media that includes computer executable instructions for controlling power (e.g., process 800, discussed below in relation to FIG. 8).

In some embodiments, the control circuitry 210 is powered by power supply 202. In some embodiments, the power supply 202 includes a car battery (e.g., a 12 V lead acid battery), a DC-DC converter, an AC power supply (e.g., generated by suitably inverting a DC power supply), any other power supply, any corresponding components (e.g., terminals, switches, fuses, and cables), or any combination thereof. In some embodiments, power supply 202 may be same as or otherwise included as part of battery system 230.

In some embodiments, user interface 206 includes a push button, a toggle switch, a turnable knob, a display screen (e.g., a touch screen), a key fob, a key-lock combination, any other suitable system or component for receiving input from a user or providing output to a user, or any combination thereof. In some embodiments, user interface 206 includes a touchscreen on the dashboard (e.g., dashboard 106 in FIG. 1) of a vehicle, configured to receive input from the user, and provide a display to the user. In some embodiments, user interface 206 includes one or more buttons that are selectable by a user. For example, the one or more buttons may include a button coupled to a switch, a button on a touchpad, any other suitable button that may be used by a user to make a selection, or any combination thereof. In some embodiments, user interface 206 includes one or more turnable knobs that a user may turn to adjust a drive mode, power options for the powered cupholder, or another suitable setting.

Sensor(s) 204 include one or more of pressure sensors (e.g., piezo or strain-based transducers, capacitive sensor, or optical pressure sensor), proximity sensors or switches (e.g., a capacitive, photoelectric, magnetic, optical, ultrasonic, or inductive proximity sensor), wireless sensors (e.g., radio frequency identification), current sensors, any other suitable sensors, or any combination thereof. For example, sensor(s) 204 may be used to measure pressure or a difference in pressure over time of a surface of the cupholder. In a further example, sensor(s) 204 may be used to identify presence of an object, such as the accessory device, in the cupholder. In a further example, sensor(s) 204 may be used to determine whether an accessory device is retained in the cupholder. In a further example, sensor(s) 204 may be used to determine whether electrical contacts of the cupholder contact electrical contacts of the accessory device. Sensor(s) 204 is also referred to herein as sensors 204, and accordingly may include one or more sensors of any suitable type or types.

Powered cupholder system 240 may be the same as or similar to, or included as part of, system 140 of FIG. 1. Powered cupholder system 240 may include sensors (e.g., sensor(s) 204), voltage regulators or other components to control power, fittings, electrical contacts, or components designed to direct and meter voltage or current to electrical contacts of the cupholder, any other suitable components, or any combination thereof. In some embodiments, powered cupholder system 240 includes control circuitry such as a controller, module, FPGA, or any other suitable circuitry to provide monitoring, control, communication, or a combination thereof.

Drive system(s) 250 may include one or more front drive units, rear drive units, or both, which may each include a motor coupled via a gearset to an output shaft that corresponds to a wheel or a drive axis of the vehicle. To illustrate, each drive unit may include a motor coupled to a gearbox having a lubricating oil system and cooling passages (e.g., for interfacing to a coolant system), wherein the motor is electrically coupled to an inverter or otherwise power electronics (e.g., a motor drive).

The vehicle control circuitry 260 performs vehicle functions. For example, the vehicle control circuitry 260 may control power between the battery system 230 and the drive system(s) 250 to control the vehicle's speed and acceleration. For example, the vehicle control circuitry 260 may control an amount of torque to the wheels of the vehicle. In some embodiments, the vehicle control circuitry 260 controls the drive train and drive train components of the vehicle. In some embodiments, the vehicle controller controls the braking system. The vehicle control circuitry 260 may receive input from a user, such as through accelerator and brake pedals.

Other systems 280 may include controllers or modules (e.g., having processors), electronics, display devices, or other suitable systems that may interface to the powered cupholder system 240 or vehicle control circuitry 260. In some embodiments, the other systems 280 include a fault diagnosis management unit, a steering motor and corresponding controller, air conditioning motor and corresponding controller, heater and corresponding controller braking system, and DC-DC converters, to name a few examples. The vehicle control circuitry may be communicatively coupled to the other systems 280 to control their functionality, or to communicate information to their controllers relating to their functionality.

Illustrative system 200 of FIG. 2, or aspects thereof, may be used to control any suitable system disclosed herein and implement any suitable method disclosed herein, in accordance with the present disclosure. In some embodiments, not all components shown in FIG. 2 need be included in system 200. In some embodiments, control circuitry 210 is configured to determine an operation mode such as off-road, wet-road, highway, city street, eco, or any other suitable mode (e.g., which defines how the system operates). For example, control circuitry 210 may execute computer readable instructions stored on non-transitory computer readable media to select from among operating modes (e.g., based on input from user interface 206), retrieve reference information (e.g., from memory), generate and transmit control signals to any system of system 200, receive and process sensor signals, or a combination thereof. System 200, or control circuitry 210 thereof, may be referred to herein as a control system (e.g., for controlling power provided to the cupholder). It will be understood that a mode, as referred to herein, corresponds to any suitable form of operation for providing power to the cupholder, controlling power to the cupholder, or a combination thereof.

FIG. 3A is a schematic cutaway illustration of a powered cupholder system 340, in accordance with some embodiments of the present disclosure. FIG. 3B is a schematic assembly illustration of the system 340, in accordance with some embodiments of the present disclosure. FIG. 3C is a schematic sectional view of the system 340 from the perspective noted in FIG. 3B, in accordance with some embodiments of the present disclosure. FIGS. 3A-3C show different views of the system 340 and an accessory device 360, and are herein described together for clarity.

Referring to FIG. 3A, the system 340 includes a cupholder 342, electrical contacts 344, sealing elements 346, grippers 348, retaining mechanism 350, and sensor 352. The cupholder 342 includes a cup well 358 having sidewalls and a base 359 at the bottom of the cup well 358. The cupholder 342 accommodates the accessory device 360, which may be disposed in the cup well 358 such as depicted in FIG. 3B. The accessory device 360 includes electrical contacts 362, retention elements 364, and sensed objects 366.

The electrical contacts 344 of the cupholder 342 are pogo pins or spring-loaded pins that protrude from the base 359. The electrical contacts 344 are electrically and communicatively coupled to control circuitry (e.g., control system 120 in FIG. 1 and control circuitry 210 in FIG. 2). The control circuitry may provide power to the electrical contacts 344 of the cupholder 342, which in turn may provide power to the accessory device 360. In one example, when the accessory device 360 is retained by the cupholder, such as depicted in FIG. 3B, the electrical contacts 362 of the accessory device 360 contact and push against the electrical contacts 344 of the cupholder 342 and the control circuitry provides power to the accessory device 360 through the electrical contacts 362. In some embodiments, the electrical contacts 344 comprise a corrosion-resistant material. In some embodiments, the electrical contacts 344 comprise gold. In some embodiments, the electrical contacts 344 are gold-plated. In some embodiments, the electrical contacts 344 are flush with the base or recessed to the base and the electrical contacts 362 of the accessory device 360 extend to contact the electrical contacts 344. In some embodiments, the electrical contacts 344 of the cupholder 342, are located on sidewalls of the cup well 358 and the electrical contacts 362 are located on sides of the accessory device 360.

Each sealing element 346 surrounds an electrical contact 344 to prevent liquids on the base 359 from contacting the electrical contacts 344. The sealing elements 346 may be placed on the base 359 or partially placed in a recess of the base 359. In one example, when the accessory device 360 is retained by the cupholder, such as depicted in FIG. 3B, the bottom surface of the accessory device 360 compresses the sealing elements 346 against the cupholder 342 to form a seal around the electrical contacts 344, such as a water-tight seal. The sealing elements 346 may include any one of O-rings, gaskets, or sealants. The sealing elements 346 may comprise any compressible material that forms a seal between the cupholder 342 and the accessory device 360, such as neoprene, rubber, nitrile, fluoroelastomer, graphite, cork, or styrene butadiene rubber, to name a few examples. In some embodiment, the sealing elements 346 may be attached to the base 359, such as through an adhesive or a friction fit.

The grippers 348 protrude from the sidewalls of the cup well 358 and engage sides of the accessory device 360 to secure the accessory device 360 in the cupholder 342. The grippers 348 provide stability when the accessory device is secured while allowing some movement or adjustment within the cup well 358. The grippers 348 allow the cupholder 342 to accommodate accessory devices 360 of different sizes or diameters. In the embodiment depicted in FIGS. 3A and 3B, the grippers 348 have an arc-like shape where the peak of the arc contacts a side of the accessory device 360. As the accessory device 360 is inserted into the cupholder 342, the grippers 348 each pivot into the sidewalls of the cup well 358 and against compliant mechanisms or elastic members, such as a spring or elastic loop, while maintaining contact with the accessory device 360. When the accessory device 360 is removed, the compliant mechanisms or elastic members pivot the grippers 348 away from the sidewalls and into the cup well 358. In some embodiments, the grippers 348 may be an elastic material that contacts the accessory device 360 and deforms and stretches to secure the accessory device 360. The deformable material returns to its original shape when the accessory device 360 is removed. In some embodiments, the grippers 348 may be any mechanism known to one skilled in the art that secure the accessory device 360 in the cupholder 342.

The retaining mechanism 350 retains the accessory device 360 in the cupholder 342 by holding the accessory device 360 in an engaged position such that the electrical contacts 344 of the cupholder 342 remain in contact with the electrical contacts 362 of the accessory device 360. In some embodiments, the seal formed by the sealing elements 346 remains intact while the accessory device 360 is retained. In some embodiments, the retaining mechanism 350 engages the retention element 364 and fixes the accessory device 360 in cupholder 342 until the retaining mechanism 350 is disengaged.

In the embodiment depicted in FIG. 3A, the retaining mechanism 350 includes a receiver or strike that forms a channel or groove to receive a retention element 364 of the accessory device. The retention element 364 is a protrusion or lever that protrudes from a side(s) of the accessory device 360. The retaining mechanism 350 is attached to, or integrally formed with, the sidewall of the cup well 358. Referring to FIGS. 3A and 3C, the accessory device 360 is inserted into the cupholder 342 such that the retention elements 364 do not engage the retaining mechanism 350. The dashed retention elements 364 in FIG. 3C show the non-engaged position. The accessory device 360 is rotated clockwise and the protrusions of the retention elements 364 enter the channel of the receiver to engage the retaining mechanism 350. The retaining mechanism 350 includes a stop at the end of the channel to contact the retention element 364 and prevent further rotation past the engaged position. The accessory device 360 is rotated counterclockwise to the non-engaged position to stop retention of the accessory device 360. In some embodiments, the channel of the retaining mechanism 350 is configured such that the accessory device 360 is rotated counterclockwise to from the non-engaged position to the engaged position. In some embodiments, the retaining mechanism 350 is attached to, or integrally formed with, the base 359. Although only one receiver of the retaining mechanism 350 is depicted in cutaway schematic of FIG. 3A, the retaining mechanism 350 may include another receiver on an opposite side of the sidewall. The another receiver is rotated 180 degrees in relation to the receiver, such as shown in FIG. 3C. In some embodiments, the receivers of the retaining mechanism 350 are positioned at a different angle in relation to one another. In some embodiments, more or less receivers may be used.

Sensors 352 of the system 340 are disposed in or on the sidewall of the cup well 358 and in the channel of the retaining mechanism 350. The sensors 352 are positioned such that when the accessory device 360 is in the engaged position, the sensed objects 366 of the accessory device 360 align with or contact the sensors 352, and are detected by the sensors 352. The control circuitry uses the sensors 352 to determine whether the accessory device 360 is retained by the retaining mechanism 350. The control circuitry further determines whether to provide power to the electrical contacts 344 of the cupholder 342 based on whether the accessory device 360 is retained by the retaining mechanism 350. For example, the control circuitry may not provide the power to the electrical contacts 344 when the accessory device 360 is determined to not be retained by the retaining mechanism 350. The sensors 352 may correspond to the sensors 204 discussed in relation to FIG. 2. In some embodiments, the sensors 352 transmit a frequency that is reflected back from the sensed objects 366 to the sensors 352. In some embodiments, the sensors 352 receive a transmission or reflection from the sensed objects 366. In some embodiments, the sensors 352 and the sensed objects 366 both transmit and receive to one another.

In some embodiments, the sensors 352 are disposed in other parts of the sidewall, in the retaining mechanism, or in the base 359. In such embodiments, the corresponding sensed objects 366 of the accessory device are placed such that they align with the sensors 352 when in the engaged position.

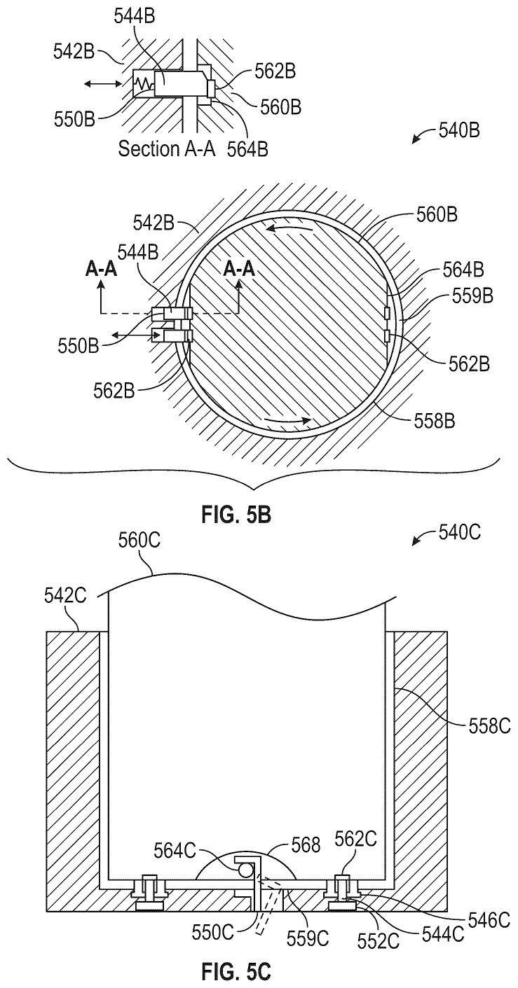

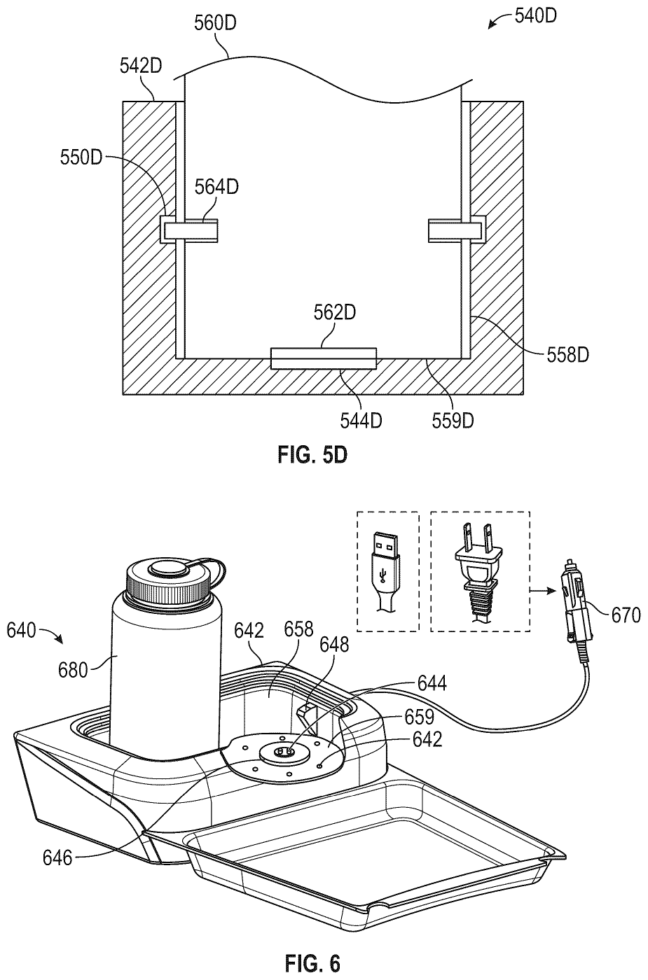

In some embodiments, sensors 352 may include pressure sensors disposed in the base 359, such as sensors 552C discussed in relation to FIG. 5C. In such embodiments, the pressure sensors may identify the presence of the accessory device 360 in the cupholder 342. For example, the pressure sensors may detect an increase in pressure on the base 359. In some embodiments, at least a portion of the electrical contacts 344 move perpendicular or orthogonal to the base 359, such as when compressed by the accessory device 360, and the pressure sensors detect the movement.

In some embodiments, the electrical contacts 344 provide a data connection to the accessory device 360. The data connection allows the control circuitry to determine the accessory device 360 is retained. In some embodiments, the data connection allows the control circuitry to identify the type of accessory device 360 and determine the power requirements. In some embodiments, the data connection allows the control circuitry to determine a current state of charge (SOC) of the accessory device 360. In such embodiments, the control circuitry may determine a charging profile for the accessory device 360 (e.g., constant amperage or amperage that varies based on time or the SOC).

Drain paths 354 or holes are formed in the base to allow fluids, such as liquids that may be spilled in the cupholder 342, to drain away from the electrical contacts 344. In some embodiments, the drain paths 354 are fluidly connected to a drain receptacle or container.

FIGS. 4A-4C are schematic assembly illustrations of another powered cupholder system 440, in accordance with some embodiments of the present disclosure. In particular, FIG. 4A shows the system 440 in a retracted position, FIG. 4B shows the system 440 in a partially extended position, and FIG. 4C shows the system 440 in a fully extended position. FIGS. 4A-4C are herein described together for clarity. The system 440 is part of a front console 408 of a vehicle (e.g., vehicle 100 in FIG. 1), although in other embodiments the system 440 may be in a different location (e.g., dashboard 106, rear console 110, or rear armrest 112 in FIG. 1) of the vehicle.

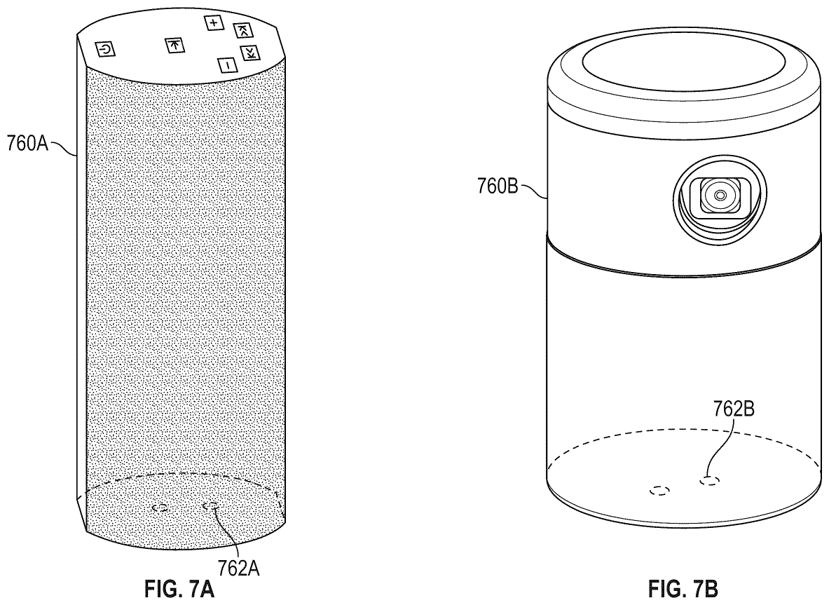

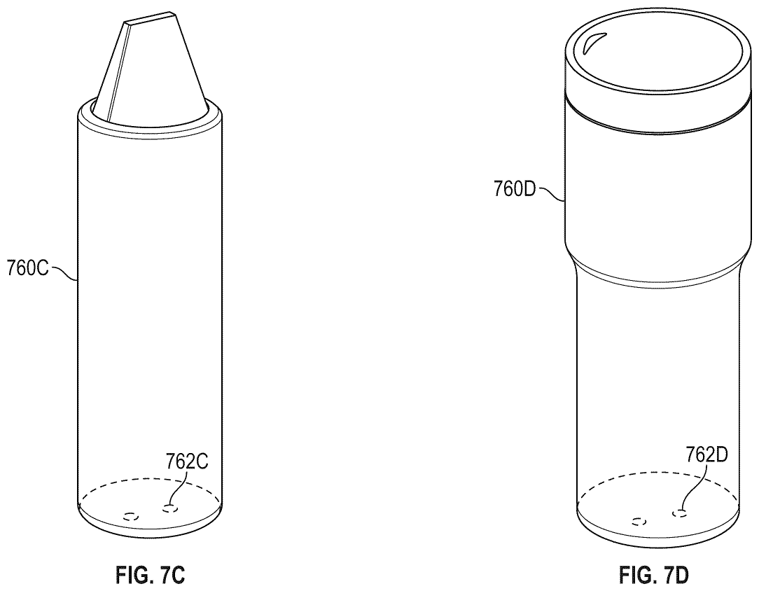

The system 440 includes a cupholder 442, retaining mechanism 450, and electrical contacts 444. The cupholder 442 includes a retaining frame 457 and a movable base 459. The retaining frame 457 forms a cup well 458 to secure sides of an accessory device (e.g., accessory device 360 in FIGS. 3A-3C and accessory device 560A-D, 760A-D, discussed below in relation to FIGS. 5A-5D, and 7). In the embodiment depicted in FIGS. 4A-4C, the cupholder 442 includes two cup wells 458 separated by material of the retaining frame 457. The cupholder 442 can receive one accessory device per cup well 458.

The movable base 459 is movable in relation to the retaining frame 457. For example, the movable base 459 pivots about an axis A (e.g., shown in FIG. 4C) located where the movable base 459 connects to the retaining frame 457. The cupholder 442 is retractable into and out of the front console 408. The movable base 459 moves away from the retaining frame 457 when the cupholder 442 is extended from the front console 408 (e.g., transitioning from FIG. 4A to FIG. 4B to FIG. 4C). The movable base 459 moves towards the retaining frame 457 when the cupholder 442 is retracted into the front console 408 (e.g., transitioning from FIG. 4C to FIG. 4B to FIG. 4A). In some embodiments, the movable base 459 is configured to stow inside the retaining frame 457 when the cupholder 442 is stowed in the compartment (e.g., as shown in FIG. 4A). A compliant mechanism or elastic member (not shown) may bias the movable base 459 to move away from the retaining frame 457. For example, when the cupholder 442 is retracted, a spring is deformed and stores energy in the form of elastic potential energy. When the cupholder is extended, the spring releases the elastic potential energy and exerts a force on the movable base 459 to pivot the movable base 459 about the axis A away from the retaining frame 457. In some embodiments, the compliant mechanism or elastic member is not used and gravity is used to pivot the movable base 459 away from the retaining frame 457. When the cupholder 442 is extended, the movable base 459 may support the bottom of the accessory device or a cup that is disposed in the cup well 458.

The electrical contacts 444 are disposed in the movable base 459. In the embodiment depicted in FIGS. 4A-4C, six electrical contacts 444 protrude from the movable base 459 such that there are three electrical contacts 444 per accessory device. In some embodiments, more or less electrical contacts 444 may be used. The electrical contacts 444 are electrically and communicatively coupled to control circuitry (e.g., control system 120 in FIG. 1 and control circuitry 210 in FIG. 2). The control circuitry may provide power to the accessory device using two of the electrical contacts 444. The control circuitry may communicate with the accessory device, such as by exchanging data, using the remaining third electrical contact 444. For example, the control circuitry may communicate with the accessory device to confirm the accessory device can receive power before providing power to the two electrical contacts 444. In some embodiments, the control circuitry may communicate with the accessory device to identify what type of accessory device is connected (e.g., one of accessory devices 760A-D, described below in relation to FIGS. 7A-7D). In some embodiments, the control circuitry may communicate with the accessory device to determine how much voltage or current to provide, which may vary with time as in adaptive charging. In some embodiments, the control circuitry may communicate with the accessory device to determine a current SOC of the accessory device.

The retaining mechanism 450 includes the electrical contacts 444. When the accessory device is placed in the cupholder 442, the electrical contacts 444 are disposed in recesses of the bottom of the accessory device and prevent the accessory device from shifting on the movable base 459. In some embodiments, the electrical contacts 444 are stationary in relation to the movable base 459 such that the accessory device rests on the electrical contacts 444 when not aligned with the recesses. In some embodiments, the electrical contacts 444 are retractable (e.g., pogo pins or spring-loaded pins). In such embodiments, the accessory device pushes the electrical contacts 444 towards the movable base 459 when not aligned with the recesses and the electrical contacts 444 extend into the recesses when aligned.

In some embodiments, the cup wells 458 are formed by a continuous opening in the retaining frame 457 such that the cup wells 458 are not completely separated by material of the retaining frame 457.

FIGS. 5A-5D are schematic illustrations of different retaining mechanisms 550A-D for a powered cupholder system 540A-D, in accordance with some embodiments of the present disclosure. FIGS. 5A-5D are herein described together for brevity.

FIGS. 5A-5D show an accessory device 560A-D disposed in a cupholder 542A-D of the system 540A-D. The cupholder 542A-D includes a cup well 558A-D and a base 559A-D. The system 540A-D includes a retaining mechanism 550A-D and electrical contacts 544A-D. The accessory device 560A-D includes a retention element(s) 564A-D and electrical contacts 562A-D.

In FIG. 5A, the retaining mechanism 550A comprises a magnetic feature on or in a sidewall of the cup well 558A. The retention element 564A comprises a magnetic feature on or in a side of the accessory device 560A. The magnet feature of the retaining mechanism 550A engages the magnetic feature of the accessory device 560A to retain accessory device 560A in the cupholder 542A. The magnetic feature of the retaining mechanism 550A may be a permanent magnet, electromagnet, or material that comprises a magnetic material (e.g., a ferromagnetic material) attracted to a magnet. The magnetic feature of the accessory device 560A may be a magnet or magnetic material that is attracted to the magnetic feature of the retaining mechanism 550A. In some embodiments, the magnetic feature of the accessory device 560A may be a permanent magnet, electromagnet, or material that comprises a magnetic material and the magnetic feature of the retaining mechanism 550A may be attracted to the magnetic feature of the accessory device 560A.

The system 540A includes sensor(s) 552A and the accessory device 560A includes a sensed object(s) 566A. The sensor 552A comprises a magnetic sensor, such as a Hall effect sensor, and the sensed object 566A comprises a magnetic material. The magnetic sensor detects a change in voltage when placed in the magnetic field of the magnetic material. The sensor 552A is used by control circuitry (e.g., control system 120 in FIG. 1 and control circuitry 210 in FIG. 2) to determine if the accessory device is retained by the system 540A. For example, sensor 552A will detect the sensed object 566A when the retaining mechanism 550A engages the retention element 564A and the electrical contacts 544A of the system 540A contact the electrical contacts 562A of the accessory device 560A.

In some embodiments, the sensor 552A is an RFID reader and the sensed object 566A is an RFID tag. In some embodiments, the sensor 552A is a camera or emitter and detector and the sensed object 566A is a visual identifier such as a QR code or a bar code. In some embodiments, the sensor 552A is an emitter and detector and the sensed object 566A is reflective surface. In some embodiments, the sensor 552A and the sensed object 566A are transceivers, such as one of an NFC, Bluetooth, or Wi-Fi transceiver, to name a few examples.

The base 559A includes an aligning feature 555 in its center, ledges 556 where the base meets the cup well 558A, and a channel 557 formed therebetween. The aligning feature 555 is shown as a wedge or chevron shape protruding outward from the base 559A into the cup well 558A and extending between sidewalls of the cup well 558A. The wedge is formed by two flat surfaces. The electrical contacts 544A are disposed on or in the retaining feature 555. The accessory device 560A forms a corresponding mating feature (e.g., an inverted wedge) in its bottom. The electrical contacts 562A of the accessory device 560A are disposed in or on the corresponding mating feature. The wedge of the aligning feature 555 aligns the accessory device 560A with the retaining mechanism 550A and the electrical contacts 544A. The ledges 556 may be along the entire sidewall of the cup well 558A or at discrete locations along the sidewall. The ledges 556 may support an outer area of the bottom of the accessory device 560A. The channel 557 may entirely or partially surround the aligning feature 555. The channel 557 is fluidly coupled to the drain paths 554. The sloped surfaces of the wedge resist standing liquids, and may direct liquids spilled on the aligning feature 555 into the channel 557 and to the drain paths 554. The drain paths 554 drain liquids away from the electrical contacts 544A of the cupholder 542A. In some embodiments, the aligning feature 555 has a conical or frustoconical shape. In some embodiments, the aligning feature 555 may be any shape that results in alignment of the electrical contacts 544A with the electrical contacts 562A.

In FIG. 5B, the retaining mechanism 550B of the system 540B comprises a lever formed by a compliant mechanism or elastic member that is part of or attached to each electrical contact 562B. In some embodiments, the electrical contact 562B may include the compliant mechanism, such as in pogo pins or spring-loaded pins. The retention element 564B comprises a receiver or strike having a slot or notch formed in opposing sides of the accessory device 560B. The electrical contacts 562B are disposed in the slot on the opposing sides. The compliant mechanism biases the electrical contacts 544B to protrude from a recess in a sidewall of the cup well 558B. When the accessory device 560B is inserted into the cupholder 542B, a side(s) of the accessory device 560B contacts a chamfered or rounded portion of the electrical contacts 544B and moves the electrical contacts 544B towards the sidewall as the accessory device 560B is inserted into the cup well 558B. Once the accessory device 560B rests in the cupholder 542B (e.g., the bottom of the accessory device 560B contacts the base 559B of the cupholder 542B), the accessory device 560B is rotated and the electrical contacts 544B of the system 540A-D move away from the sidewall and toward the accessory device 560B to engage the slot to retain the accessory device 560B. When properly seated, the electrical contacts 544B contact the electrical contacts 562B of the accessory device 560B. In some embodiments, the electrical contacts 544B are flexible or elastically deformable such that they form the compliant mechanism. The accessory device 560B may be removed from the cupholder 542B by rotating the accessory device 560B to push the electrical contacts 544B into the sidewall of the cup well 558B until the electrical contacts 544B are no longer disposed in the slot of the retention element 564B. The accessory device 560B may then be lifted out of the cupholder 542B.

In FIG. 5C, the retaining mechanism 550C comprises a latch on or in the base 559C of the cupholder 542C. The retention element 564C comprises a receiver or strike having a bar or peg spanning a recess 568 formed in the bottom of the accessory device 560B. The electrical contacts 544C of the system 540C protrude outwardly from the base 559C into the cup well 558C. Sealing elements 546C are partially disposed in and secured in the base 559C and surround the electrical contacts 544C. Control circuitry (e.g., control system 120 in FIG. 1 and control circuitry 210 in FIG. 2) moves the retaining mechanism 550C (e.g., such as from a position shown as a dashed outline) through the recess 568 to engage the retention element 564C when the electrical contacts 544C contact the electrical contacts 562C of the accessory device 560C. The control circuitry locks the accessory device 560C in the cupholder 542C by pulling the accessory device 560C towards the base 559C and locking the retaining mechanism 550C. The control circuitry locks the accessory device 560C in the cupholder 542C by fixing the accessory device in cupholder 542C such that it cannot be removed until unlocked. When the accessory device 560C is pulled towards the base 559C, the sealing elements 546C are compressed and form a seal around the electrical contacts 544C.

The system 540C includes sensors 552C. Each electrical contact 544C protrudes from the base 559C at a first end and may contact a sensor 552C at an opposite second end. The electrical contacts 544C are pogo pins and the sensors 552C are pressure sensors. The pressure detected by the sensors 552C increases when the accessory device 560C rests on the electrical contacts 544C. Control circuitry (e.g., control system 120 in FIG. 1 and control circuitry 210 in FIG. 2) may use the sensors 552C to determine if the accessory device 560C is present in the cupholder 542C.

In some embodiments, the weight of the accessory device 560C is known and the control circuitry uses the pressures detected by the sensors 552C to determine if an object present in the cupholder 542C is the accessory device 560C. For example, if the detected pressures are outside of an expected pressure range, then the control circuitry determines the accessory device 560C is not present and does not provide power to the electrical contacts 544C.

In some embodiments, the system 540C receives an input from a user through a button or switch (not shown) to activate the latch of the retaining mechanism 550C.

In some embodiments, the sensors 552C may further comprise a sensor for checking continuity, a conductivity sensor, or a resistance sensor that is electrically or communicatively coupled to at least one electrical contact 544C. The control circuitry compares the measurements of the sensors 552C, which may be taken using the electrical contacts 544C, to a predetermined value or range to determine if the electrical contacts 544C contact the electrical contacts 562C of the accessory device 560C. For example, the reading from such sensors may differ when the electrical contacts 544C contact the bottom of the accessory device 560C and contact the electrical contacts 562C of the accessory device 560C.

In some embodiments, the electrical contacts 544C move vertically (as shown on the page) and the sensors 552C provide readings when the electrical contacts 544C move downward and contact the sensors 552C. In such embodiments, the sensors 552C may be contact or conductivity sensors. The control circuitry may not provide power when the sensors 552C do not detect contact with the electrical contacts 544C.

In FIG. 5D, the retaining mechanism 550D comprises a recess(es) (e.g., a slot, hole, or notch) formed in the sidewall of the cup well 558D. The retention element 564D comprises a lever on or in a side(s) of the accessory device 560D. Once the accessory device 560D rests in the cupholder 542D and is positioned to be retained, the retention element 564D is moved into the retaining mechanism 550D to engage the recess and retain the accessory device 560D. In some embodiments, the control circuitry communicates with and/or sends power to the retention element 564D to move the retention element 564D to engage the retaining mechanism 550D. In some embodiments, the control circuitry communicates with and/or sends power to the retention element 564D through the electrical contacts 544D, 562D. In some embodiments, the accessory device 560D comprises control circuitry and the control circuitry of the system 540D communicates with the control circuitry of the accessory device 560D (e.g., through I/O circuitry or through I/O 216) to move the retention element 564D. In some embodiments, the control circuitry may use the retaining mechanism 550D to lock the accessory device 560D in the cupholder 542D.

The electrical contacts 544D of the system 540D provide wireless power to the electrical contacts 562D of the accessory device 560D. The electrical contacts 544D may include a receiver coil(s) and the electrical contacts 562D include a transmitter coil(s). The control circuitry searches for the receiver coil, and when detected, provides electrons to the transmitter coil to generate a magnetic field. The magnetic field induces an electrical current in the receiver coil to provide the power. In some embodiments, the wireless power is provided using induction wireless charging. In some embodiments, the wireless power is provided using resonant wireless charging. In some embodiments, the electrical contacts 544D may include a plurality of receiver coils that may be used to detect an orientation of the accessory device 560D. In such embodiments, the retention element 564D engages the retaining mechanism 550D when the two are properly aligned.

Although FIGS. 5A-5D provide examples of different retaining mechanisms 550A-D, they are not to be considered limiting. In some embodiments, the retaining mechanisms 550A-D may include any features or combination of features that retain an accessory device in a cupholder.

FIG. 6 is a schematic illustration of a powered cupholder system 640, in accordance with some embodiments of the present disclosure. The system 640 may be used with a vehicle that that does not have powered cupholders, and may be placed on the vehicle floor between the center console and the front console. The system 640 includes a cupholder 642, electrical contacts 644, sealing elements 646, grippers 648, plug 670, and control circuitry (e.g., control system 120 in FIG. 1 and control circuitry 210 in FIG. 2). The cupholder 642 includes cup wells 658 and a base 659. The cup wells 658 are formed by a continuous opening in the cupholder 642 such that the cup wells 658 are not separated by a sidewall. In the embodiment depicted in FIG. 6, a non-powered, refillable water bottle 680 is disposed in one of the cup wells 658.

The plug 670 provides power to the system 640 and the control circuitry may provide power to the electrical contacts 644. The control circuitry may recognize the refillable water bottle 680 is not an accessory device and cannot receive power. As a result, the control circuitry may refrain from providing power to the electrical contacts 644.

In the embodiment depicted in FIG. 6, the plug 670 comprises a vehicle cigarette lighter plug that may plug into a cigarette lighter outlet of the vehicle. In some embodiments, the plug 670 is a NEMA 1-15P (two-pole, no ground) or NEMA 5-15P (two-pole with ground pin) plug. In such embodiments, the plug 670 may be plugged into an outlet of the vehicle or another outlet, such as in a home. In some embodiments, the plug 670 may be a USB plug or other data and/or power connector. In such embodiments, the plug 670 may further provide an I/O path (e.g., via I/O 216) that communicatively couples the control circuitry of the system 640 to another control circuitry, such as the vehicle control circuitry 260 discussed in relation to FIG. 2. Although a few examples of plug types are discussed, they are not to be considered limiting.

In some embodiments, the system 640 may use a retaining mechanism (e.g., retaining mechanism 350, 450, 550A-D in FIG. 3A, FIG. 4, and FIGS. 5A-5D) to retain an accessory device in the cupholder 642. In some embodiments, the system 640 may use sensors (e.g., sensors 204, 352, 552A and 552C in FIGS. 2, 3A, 5A, and 5C) to determine if the accessory device is present or retained in the cupholder 642.

FIGS. 7A-7D are schematic illustrations of powered cupholder system, in accordance with some embodiments of the present disclosure. The accessory devices 760A-D include electrical contacts 762A-D to receive power from a powered cupholder system (e.g., powered cupholder system 240, 340, 440, 540A-D, 640 in FIGS. 2, 3A-C, 4, 5A-5D, and 6). The accessory devices 760A-D may contain a battery that is charged by the powered cupholder system. The accessory devices 760A-D may be removed from the vehicle when used.

In FIG. 7A, the accessory device 760A is a speaker. The speaker includes a power button, input button, volume buttons, and previous/next song buttons. The speaker may receive input wirelessly (e.g., Bluetooth, Wi-Fi, etc.) and/or may include input ports to receive a wired input (e.g., 3.5 mm auxiliary, RCE, optical audio, speaker wire, etc.). In some embodiments, the speaker may include more, less, or no buttons. In FIG. 7B, the accessory device 760B is a projector. The projector may include a speaker(s). The projector may receive input wirelessly and/or may include input ports to receive a wired input (e.g., HDMI, VGA, DVI, DisplayPort, USB, BNC, SMA, RCE, component video, etc.). In some embodiments, the projector may receive input from control circuitry (e.g., control system 120 in FIG. 1 and control circuitry 210, 260 in FIG. 2). In FIG. 7C, the accessory device 760C is a vacuum. The vacuum may include an on-off switch or button. In FIG. 7D, the accessory device 760D is a cup that may heat and/or cool a liquid inside the cup. The cup includes a heating and/or cooling element to heat and or/cool a liquid disposed therein. The cup may be insulated to maintain a temperature of a liquid disposed therein and/or to limit a temperature of an exterior of the cup to be held by a hand. In some embodiments, the control circuitry may control power provided to the cup. For example, the control circuitry may limit an amount of power or a duration of power provided to prevent over heating or cooling. In some embodiments, the cup includes a temperature sensor and the control circuitry uses readings from the temperature sensor to control power to the cup.

In some embodiments, the accessory device may include any one of a ultraviolet (UV) sanitizer, water bottle with a UV sanitizer, power bank, power inverter, coffee or espresso maker, coffee bean grinder, battery-powered lantern, flashlight, soap or sanitizer dispenser, hand warmer, air compressor, self-priming pump for portable sink faucet, air purifier, scent diffuser, or a camera, to name a few examples.

In some embodiments, the accessory devices 760A-D contain a port or outlet to receive a charging cable to connect to another power source (e.g., an electrical outlet). In some embodiments, an adapter may be used to connect the electrical contacts 762A-D to another power source. For example, the adapter may be a charging station or docking station located outside the vehicle.

FIG. 8 is a flowchart of an illustrative process 800 for providing power to a cupholder (e.g., cupholder 342, 442, 542A-D, 642 in FIGS. 3A-3C, 4, 5A-5D, and 6), in accordance with some embodiments of the present disclosure.

The process 800 starts at operation 802 with control circuitry (e.g., control system 120 in FIG. 1 and control circuitry 210 in FIG. 2) monitoring the cupholder for the presence of an accessory device (e.g., accessory device 360, 560A-D, 760A-D in FIGS. 3A-3C, 5A-5D, and 7).

The process 800 continues to operation 804 with the control circuitry determining if an accessory device is present in cupholder, such as described above with respect to FIGS. 2, 3A-3C, and 5C. In some embodiments, a sensor (e.g., sensors 204, 352, 552A and 552C in FIGS. 2, 3A, 5A, and 5C) is used by the control circuitry to detect if the accessory device is present. In some implementations, the control circuitry determines the accessory device is present when the data from the sensor exceeds a threshold. In some embodiments, the sensor may be any of a pressure continuity, conductivity, or resistance sensor. If the determination at operation 804 is no, then the process 800 continues to operation 802.

If the determination at operation 804 is yes, then the process 800 continues to operation 806 with the control circuitry monitoring the cupholder for the retention of the accessory device.

The process 800 continues to operation 808 with the control circuitry determining if the accessory device is retained in the cupholder, such as described above with respect to FIGS. 2, 3A-3C, 5A, and 6. In some embodiments, a retaining mechanism (e.g., retaining mechanism 350, 450, 550A-D in FIG. 3A, FIG. 4, and FIGS. 5A-5D) is used to retain the accessory device in the cupholder. In some embodiments, the control circuitry determines the accessory device is retained when the data from the sensor exceeds a threshold. In some embodiments, the accessory device includes a sensed object (e.g., sensed object 366 and 566A in FIGS. 3A-3C and 5A) that is positioned be the sensor when the accessory device is retained. In such embodiments, the sensor may be any of an RFID reader, camera, or transceiver that reads, senses, or communicates with the sensed object when the accessory device is retained. If the determination at operation 808 is no, then the process 800 continues to operation 806. For example, the control circuitry determines to not provide the power to electrical contacts (e.g., electrical contacts 344, 444, 544A-D, 644 in FIGS. 3A, 4, 5A-5D, and 6) of the cupholder when the accessory device is determined to not be retained by the retaining mechanism.

If the determination at operation 808 is yes, then the process 800 continues to operation 810 with the control circuitry determining if a request was received to lock the accessory device in the cupholder. If the determination at operation 810 is yes, then the process 800 continues to operation 812 with the control circuitry locking the retaining mechanism. The process 800 continues to operation 814 with the control circuitry monitoring the cupholder for a request to power the accessory device. If the determination at operation 810 is no, then the process 800 continues to operation 814.

The process 800 continues to operation 816 with the control circuitry determining if a request was received to provide power to the accessory device. In some embodiments, the sensor sends the request. For example, the control circuitry may determine to provide power when the sensor data indicates the accessory device is retained by the cupholder. In some embodiments, the accessory device is communicatively coupled to the control circuitry and the accessory device sends the request. In some embodiments, the accessory device comprises an interactive control or button that when activated or pressed, sends a signal to the control circuitry to request power. In some embodiments, control circuitry of the accessory device may send the request to the control circuitry of the system (e.g., via I/O circuitry). If the determination at operation 816 is no, then the process 800 continues to operation 814.

If the determination at operation 816 is yes, then the process 800 continues to operation 818 with the control circuitry providing power to the accessory device in the cupholder. In some embodiments, the control circuitry provides the power to the electrical contacts of the cupholder for a predetermined amount of time. In some embodiments, the control circuitry provides the power until the accessory device is fully charged. In some embodiments, the control circuitry provides power until the accessory achieves a target temperature (e.g., of a beverage). In some embodiments, the control circuitry is communicatively coupled to vehicle control circuitry that performs vehicle functions and the vehicle control circuitry provides the power from the vehicle to the electrical contacts. In such embodiments, the control circuitry may request the vehicle control circuitry provide the power based on any one of the determinations that the accessory device is retained in the cupholder, that the retaining mechanism is locked, or that the control circuitry either received a request or provided a request to power the accessory device.

The process 800 continues to operation 820 with the control circuitry determining if conditions are satisfied to continue providing power to the accessory device in the cupholder. If the determination at operation 820 is yes, the process 800 continues to operation 818. If the determination at operation 820 is no, then the process 800 continues to one of operations 802, 806, or 814 based on what conditions were not satisfied. For example, if the control circuitry determines the accessory device is not present in the cupholder, the process continues to operation 802. If the control circuitry determines the accessory device is present in the cupholder and is not retained, then the process 800 continues to operation 806. In some embodiments, if the control circuitry determines the accessory device is retained in the cupholder and power is no longer provided to the cupholder, then the process 800 continues to operation 814.

In some embodiments, operations 802 and 804 are optional. In such embodiments, the process 800 may start at operation 806.

In some embodiments, when the decision at operation 808 is yes, the process 800 continues to operation 814 and does not determine whether to lock the accessory device in the cupholder. In some embodiments, when the decision at operation 808 is yes, the process 800 continues to operation 818 and does not determine if a request was received to provide power to the accessory device.

In some embodiments, the determination at operation 820 is no when a user leaves the vehicle and/or the vehicle is locked. In some embodiments, the determination at operation 820 is no when power is not provided to accessories. In some embodiments, the determination at operation 820 is no when the engine is off or not running.

In some embodiments, power is always provided when the vehicle is being operated. In some embodiments, power is always provided when power is provided to accessories and the engine is off. In some embodiments, power is always provided when the engine is on or running.

The foregoing is merely illustrative of the principles of this disclosure and various modifications may be made by those skilled in the art without departing from the scope of this disclosure. The above-described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A system comprising:
a cupholder of a vehicle configured to receive and provide power to an accessory device, the cupholder comprising electrical contacts configured to engage electrical contacts of the accessory device; and
control circuitry configured to:
determine whether to provide the power to the electrical contacts of the cupholder.

2. The system of claim 1, the cupholder further comprises a retaining mechanism configured to retain the accessory device in the cupholder.

3. The system of claim 2, the control circuitry is further configured to:
determine whether the accessory device is retained by the retaining mechanism; and
determine whether to provide the power to the electrical contacts of the cupholder based on whether the accessory device is determined to be retained by the retaining mechanism.

4. The system of claim 3, the control circuitry is further configured to not provide the power to the electrical contacts when the accessory device is determined to not be retained by the retaining mechanism.

5. The system of claim 2, wherein the retaining mechanism forms a channel configured to engage the accessory device when the accessory device is rotated in the cupholder.

6. The system of claim 2, wherein the retaining mechanism comprises a first magnetic feature configured to engage a second magnetic feature on the accessory device.

7. The system of claim 2, wherein the control circuitry is further configured to lock and unlock the retaining mechanism.

8. The system of claim 1, the cupholder further comprises:
a retaining frame forming a cup well to secure sides of the accessory device; and
a movable base to support the bottom of the accessory device, wherein:
the movable base is movable in relation to the retaining frame; and
the electrical contacts of the cupholder are disposed in the movable base.

9. The system of claim 8, wherein:
the cupholder is retractable; and
the movable base is configured to:
move towards the retaining frame when the cupholder is retracted into a compartment of the vehicle; and
move away from the retaining frame when the cupholder is extended from the compartment.

10. The system of claim 9, wherein the movable base is configured to stow inside the retaining frame when stowed in the compartment.

11. The system of claim 1, the cupholder further comprising a sealing element surrounding at least one electrical contact of the cupholder, wherein the sealing element is configured to form a seal between the cupholder and the accessory device when the accessory device is retained.

12. The system of claim 1, wherein a base of the cupholder forms drain paths configured to drain liquids away from the electrical contacts of the cupholder.

13. The system of claim 1, wherein the control circuitry is configured to provide the power to the electrical contacts of the cupholder for a predetermined amount of time.

14. The system of claim 1, wherein the control circuitry is configured to provide the power to the electrical contacts of the cupholder until the accessory device is fully charged.

15. The system of claim 1, wherein the accessory device is a speaker, vacuum, or projector.

16. The system of claim 1, wherein:
the control circuitry of the system is communicatively coupled to vehicle control circuitry that performs vehicle functions; and
the vehicle control circuitry provides the power from the vehicle to the electrical contacts.

17. A method comprising:
identifying a presence of an accessory device in a cupholder; and
determining whether to provide power to the accessory device.

18. The method of claim 17, wherein the determining whether to provide the power to the accessory device comprises determining the accessory device is retained in the cupholder.

19. The method of claim 17, further comprising locking the accessory device in the cupholder.

20. A system comprising:
a cupholder of a vehicle configured to receive an accessory device and provide power to the accessory device, the cupholder comprising:
a retaining frame forming a cup well to secure sides of the accessory device;
a movable base to support the bottom of the accessory device, wherein the movable base is movable in relation to the retaining frame; and
electrical contacts disposed in the movable base configured to engage electrical contacts of the accessory device; and
control circuitry configured to provide the power to the electrical contacts of the cupholder to charge the accessory device.
